(19) United States
(12) Patent Application Publication
(10) Pub. No.: US 2002/0165941 A1
(43) Pub. Date: Nov. 7, 2002

(54) Network area storage block and file aggregation

(76) Inventors: Richard A. Gahan, Gory (IE); Martin J. O'Riordan, Maynooth (IE)

Correspondence Address: NIXON & VANDERHYE P.C., 8th Floor, 1100 North Glebe Rd., Arlington, VA, 22201-4714, US

(21) Appl. No.: 10/046,773

(22) Filed: Jan. 17, 2002

(30) Foreign Application Priority Data
Feb. 27, 2001 (GB) 0104834.7

(51) Int. Cl. G06F 15/16

(52) U.S. Cl. 709/219

(57) ABSTRACT

A system for allowing storage servers that operate on an external file level protocol to be incorporated in a storage network that operates with a block level protocol. A functional unit in a main server aggregator 3 retains a block map referred to files on the file level server. The block map is input to the aggregation layer of the aggregator server as if it were a block level store. Block access requests are mapped back to the relevant file and file offset location and the functional unit sends file protocol access requests to the remote file level server and has a file access acceleration system.

### FIELD OF THE INVENTION

This invention relates to storage and to combined block level and file level storage.

### BACKGROUND OF THE INVENTION

Server machines are used to provide (or serve) data to other devices (or clients). This may be in the context of a network to which both server and client are connected, or via an Internet connection. The data store may be provided within the chassis of the server itself, for example in the form of a disk drive. However, it is now often the case that the data store is remote from the server, in the form of a storage area network (SAN). The SAN can be accessed by the server using a protocol such as fibrechannel.

In the most commonly used protocol layering on servers there is a functional unit which accesses block based data, i.e. data is read from or written to the data store in multiples of the block size, which typically is 512 bytes. SCSI and IDE buses support this block access protocol, so do fibrechannel devices.

Clients most commonly access the server using a file access protocol and the server converts this file access into a data store block access.

However, there are storage devices that operate at file level which it is desirable to utilise within a block level protocol.

### SUMMARY OF THE INVENTION

The present invention is directed towards incorporation of a data store that supports a file access protocol within a block access protocol storage area network.

According to the invention there is provided a storage area network having an aggregator server that can access at least one remote storage server, the aggregator server operating on a block level protocol and the remote storage server operating on a file level protocol, the aggregator server having a functional unit that maps files of the remote storage server to a respective series of blocks and inputs the block map to a block storage aggregation layer.

### BRIEF DESCRIPTION OF THE DRAWINGS

The invention is now described by way of example with reference to the accompanying drawings in which

FIG. 1 schematically illustrates a server, network and storage area of a general type.

FIG. 2 is a schematic diagram of a server, network and storage area employing a system according to the invention.

FIG. 3 is a schematic diagram illustrating a read request sent to a storage area in accordance with the invention.

### DETAILED DESCRIPTION OF PREFERRED EMBODIMENT

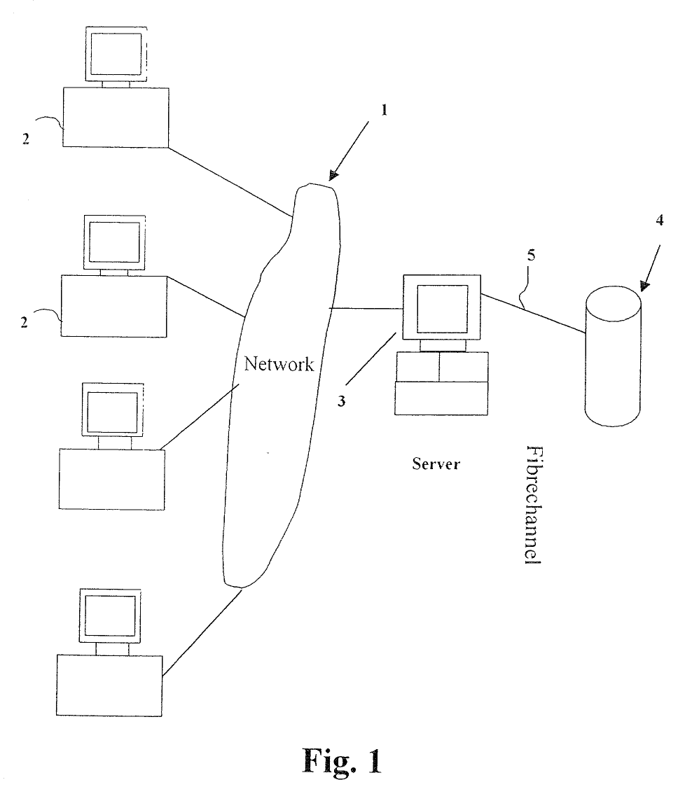

Referring to FIG. 1, a network 1 includes a plurality of client devices 2, and a server 3. It will be appreciated that the network may be a LAN, WAN or other form of network and of more complex configuration than that shown in the drawing. Older systems may have ended at a network and server configuration, with all storage being provided locally on the server. However, nowadays remote storage 4, usually in the form of a network of storage devices is provided and linked to the server via a suitable link such as a fibrechannel connection 5. The server may also include storage itself. Under the usual protocols for newer systems, the server receives file level requests from the clients and accesses data at block level. Thus storage devices operating on a file level protocol such as NFS or CIFS cannot normally be utilised in this system. However, there are still many such file level protocol servers which it is desirable to be able to incorporate into systems rather than replace in their entirety.

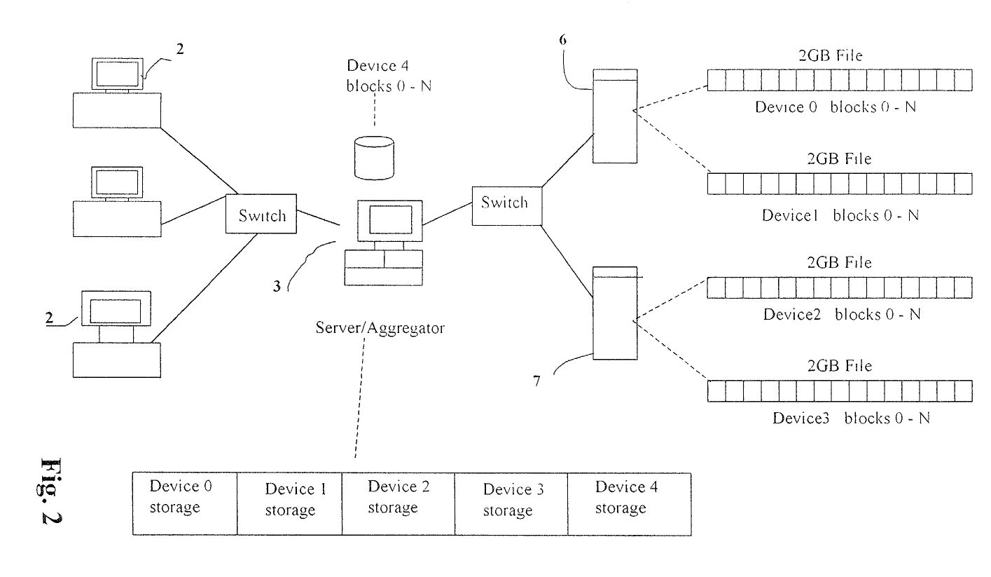

In the present invention software on a server that operates on a block level protocol enables it to utilise remote file protocol storage servers. Referring now to FIG. 2, the operation of the software is illustrated schematically. For simplicity the figure does not show a block level SAN as well, but it will be appreciated that this may also be attached to the server to operate along with the file protocol servers.

The server/aggregator 3 for the storage devices is attached to file level storage servers 6 and 7. These may be legacy NFS or CIFS servers. The server/aggregator 3 also has its own internal storage device.

Functional software on the server 3 opens large files, say of 2 gigabytes, on the remote legacy file level servers, and allocates a device identifier to the files. As shown in FIG. 2 file server 6 has files identified as Device 0 and Device 1, and file server 7 has files identified as Device 2 and Device 3. In reality there will often be many more files, but for illustration purposes only two per file server are shown.

Each of the device files is treated as a succession of blocks of storage space by the functional software on server 3 which also generates a block map of each file in which individual blocks map to specific sections of their respective file. The block map is then presented to the block aggregation layer on the server 3 as if it were an internal block based data store. The server block aggregation function is unaware that the blocks of data actually reside remotely over the network in a file. Thus the server block aggregation function is able to use the remote data store 6 and 7 even though their external interfaces do not support a block based protocol.

An example of how the block mapping may be achieved for the configuration illustrated in FIG. 2 in now given. Devices 0, 1, 2 and 3 are the files on the legacy servers as eplained above and Device 4 is a native block device, such as a SCSI or IDE based disk drive internal to the server 3.

Table 1 below shows how blocks within a file can be identified and located.

TABLE 1
Network Block Device 0 Block Map to File offset translation Database

| | |
|---|---|
| Foreign file name | file0 block |
| File size | 2 GB |
| Block size | 512 Bytes |
| Total number of blocks | 0-N |
| File offset Formula | Block Number *512 |

This File offset Formula gives, for example-
Block 0 → 0*512 = 0
Block 1 → 1*512 = 512 bytes offset into file
Block 2 → 2*512 = 1024 bytes offset into file
and so on

The functional software on the server 3 has a network block device to file offset translation database for each device, that is a similar database as shown in Table 1 in respect of device 0, for each of the devices 1, 2 and 3.

The server/aggregator 3 also has a device mapping database that points to the translation database for the file devices 0, 1, 2 and 3 and to the internal address for local device 4. If other block devices were attached to the network, their addresses would also be given in this database. For example

TABLE 2
Device Mapping Database

| | |
|---|---|
| Device 0 (Network File) | Ptr to Device 0 translation database |
| Device 1 (Network File) | Ptr to Device 1 translation database |
| Device 2 (Network File) | Ptr to Device 2 translation database |
| Device 3 (Network File) | Ptr to Device 3 translation database |
| Device 4 (Native Block Device) | Ptr to Device 4 Hardware Address and type |

Within the aggregation layer of Server 3 there is then the usual mapping of logical blocks to device number and device block number. This logical mapping is as follows

TABLE 3
Logical Block to Device mapping database

| | |
|---|---|
| Total logical Block space 0 | 5 N |

| | |
|---|---|
| Logical Blocks- 0 N | map to Device 0 Block 0 to N |
| Logical Blocks- N + 1 2N | map to Device 1 Block 0 to N |
| Logical Blocks- 2N + 1 3N | map to Device 2 Block 0 to N |
| Logical Blocks- 3N + 1 4N | map to Device 3 Block 0 to N |
| Logical Blocks- 4N + 1 5N | map to Device 4 Block 0 to N |

From these mapping tables the block aggregator functions in the server 3 can find and access any logic block in the system.

The above description illustrates the mapping required to incorporate a file in a remote device into block based storage accessed via the server 3. Compared with an aggregator for block based storage devices, the Table 1 translation database is additional and is pointed to by the pointers of Table 2 instead of Table 2 pointing to an address of the device itself. In terms of the access procedure, the mapping is used in the reverse order to that described.

An access procedure may consist of a client initiating a request such that the server 3 needs to access a logic block. First the requested logical block is mapped to a device as shown in Table 3. Then the device number is mapped to a device type as shown in Table 2. When the device type is a file type block the pointer of Table 2 takes the process to the block to file lookup of Table 1 which provides the file access information including the file offset and length defining the amount of data to be read or written. The file protocol based access to the remote file based storage can then be made and the required data (identified within the file by the offset and length) read or written to

A disadvantage of incorporating a file server in this way is that once an access request to the file server has been made the response is slow if returned via the usual channels with data being copied as it is returned from TCP to CIFS and then block interfaces within the aggregator Server 3.

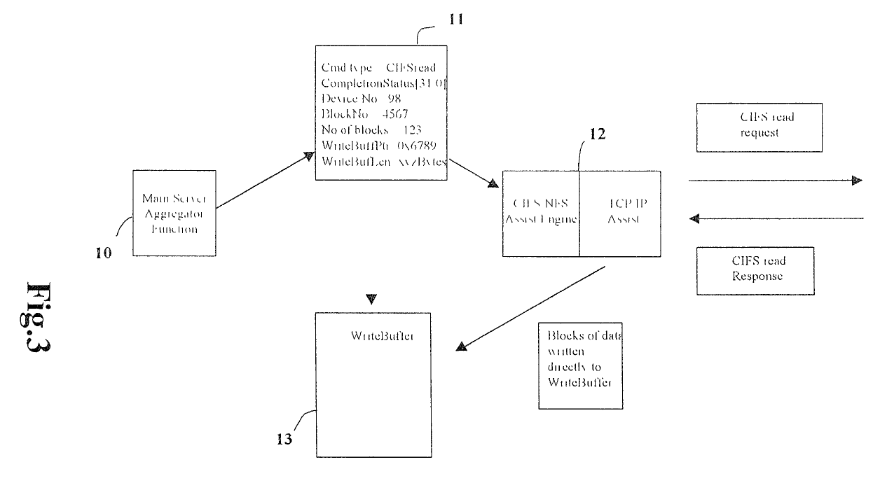

FIG. 3 shows an implementation of the invention in which the return of data is accelerated by direct placement into the required buffer.

In FIG. 3 the main server/aggregator function 10 identifies a read request shown by the read command box 11, which is input to a combined CIFS (or NFS) and TCP/IP Engine 12 which generates a CIFS PDU for a read (or write) request of the location and amount of data requested by the aggregator process and this request is sent to the file server.

The read command box 11, in addition to sending the request to the Engines 12, also establishes the buffer location and size, indicated as write buffer 13, into which the returning data is to be put. It will be noted that the pointers to this buffer define the location and length in terms of bytes. Buffer 13 may be regarded as an application buffer as it is from there that the next step of the process using the data will proceed.

When the CIFS (or NFS) read response returns to the engine 12 from the remote file server, the Engines parse the CIFS headers by examining the TCP/IP receive stream for READ responses and detecting if the read response corresponds with the expected response. When the expected response is received the CIFS data is placed directly into the write buffer 13 without having to be copied over the TCP and CIFS interfaces. The IP, TCP and CIFS headers are processed in the Engine 12. This avoids the data having to be copied over several interfaces and results in a faster response.

The file to block translation table may conveniently be within the Engine 12, although it could be elsewhere at an earlier stage if desired.

1. A storage area network having an aggregator server (3) that can access at least one remote storage server (6, 7), the aggregator server operating on a block level protocol and the remote storage server operating on a file level protocol,
the aggregator server (3) having a functional unit that maps files of the remote storage server to a respective series of blocks and inputs the block map to a block storage aggregation layer.

2. A storage area network according to claim 1 in which the functional unit has a translation database of files to blocks and the aggregator layer has a pointer to the translation database.

3. A storage area network according to claim 1 or claim 2 in which the functional unit provides a pointer to an application buffer and data from the remote storage server is placed directly into the application buffers from received transport protocol data units.

4. A method of aggregating remote file level storage in a block level aggregation process the method comprising
defining a file of the remote file level storage as a series of blocks,
maintaining a record of the block locations within the file,
providing the series of blocks for aggregation in the block level aggregation process and
providing access to the record of the block locations within the file from the aggregation process.

5. A method according to claim 4 in which data retrieval speed is increased by establishing a retrieved data buffer location when an access request is transmitted to the remote file level storage, parsing headers of the return data units and placing the data bytes directly into the retrieved data buffers.

6. A method according to claim 4 or claim 5 in which each file is given a device identifier and the block level aggregator process has a total logical block to device identifier and block mapping database and a device mapping database with pointers to the record of block locations.
